(19) United States
(12) Patent Application Publication
(10) Pub. No.: US 2024/0202999 A1
(43) Pub. Date: Jun. 20, 2024

(54) METHOD AND APPARATUS FOR ORGANIZING AND MERGING SCENE UNDERSTANDING INFORMATION OF ARTIFICIAL INTELLIGENCE AGENT

(71) Applicant: ELECTRONICS AND TELECOMMUNICATIONS RESEARCH INSTITUTE, Daejeon (KR)

(72) Inventor: Yong-Ju LEE, Daejeon (KR)

(73) Assignee: ELECTRONICS AND TELECOMMUNICATIONS RESEARCH INSTITUTE, Daejeon (KR)

(21) Appl. No.: 18/480,177

(22) Filed: Oct. 3, 2023

(30) Foreign Application Priority Data
Dec. 19, 2022 (KR) 10-2022-0178220

(51) Int. Cl. G06T 11/20; G06V 20/70

(52) U.S. Cl. CPC G06T 11/206; G06V 20/70; G06V 2201/07

(57) ABSTRACT

Disclosed herein is a method for organizing and merging scene understanding information of an AI agent. The method includes acquiring an image of a first space, recognizing objects in the image, structuring information about the relationship between the object and information about the states of the objects in the form of a graph, and merging the structured information with information received from a nearby AI agent.

### CROSS REFERENCE TO RELATED APPLICATION

This application claims the benefit of Korean Patent Application No. 10-2022-0178220, filed Dec. 19, 2022, which is hereby incorporated by reference in its entirety into this application.

### BACKGROUND OF THE INVENTION

### 1. Technical Field

The present disclosure relates to technology for scene understanding by various agents to which artificial intelligence (AI) technology is applied.

More particularly, the present disclosure relates to technology for organizing scene understanding information using visual information acquired by an AI agent, exchanging the same with a nearby agent, and merging the same with that acquired by a nearby agent.

### 2. Description of the Related Art

The present disclosure intends to remedy problems arising in understanding and expressing (organizing) visual information in various robots and the like equipped with AI. Conventional technology is limited to a method that forms a scene graph based on the relationship of objects detected in a certain scene. For example, when a table is present in a room and when a cup is on the table, the table, and the cup are connected (room-table-cup), and the expression that the room, the table, and the cup are in the room and the cup is on the table is used.

However, the conventional technology has a disadvantage in that pieces of scene understanding information generated by multiple agents are not efficiently exchanged and merged, so technology capable of solving this problem is urgently required.

### DOCUMENTS OF RELATED ART

(Patent Document 1) Korean Patent Application Publication No. 10-2022-0146726, titled “Travel planning device and method and mobile robot using the same”.

### SUMMARY OF THE INVENTION

An object of the present disclosure is to generate scene understanding information including the relationship between objects based on scene information acquired by an AI agent.

Another object of the present disclosure is to efficiently exchange and merge pieces of scene understanding information respectively generated by multiple AI agents.

In order to accomplish the above objects, a method for organizing and merging scene understanding information of an AI agent according to an embodiment of the present disclosure includes acquiring an image of a first space, recognizing objects in the image, structuring information about the relationship between the objects and information about the states of the objects in the form of a graph, and merging the structured information with information received from a nearby AI agent.

Here, the objects may be recognized based on a first AI neural network that is pretrained by receiving an image of a specific space as input, and the information about the states of the objects may be acquired by inputting the objects to a second AI neural network that is trained based on training data, which is formed by labeling objects with respective states.

Here, merging the structured information may comprise merging information corresponding to the first space with information corresponding to a second space of the nearby AI agent.

Here, the merged information may be configured such that the positional relationship between the first space and the second space is represented in the form of a link.

Here, merging the structured information may comprise determining whether to merge the structured information with the information received from the nearby AI agent based on metadata of the nearby AI agent, and the metadata may include timestamp information corresponding to the information about the states of the objects.

Here, merging the structured information may comprise merging the information about the states of the objects determined to have been updated within a preset time period back from the current time using the timestamp information.

Here, merging the structured information may comprise exchanging information about an object, the state of which changes over time, with the nearby AI agent.

Here, merging the structured information may comprise exchanging information in units of sentences generated based on the information about the states of the objects with the nearby AI agent.

Also, in order to accomplish the above objects, an apparatus for organizing and merging scene understanding information of an AI agent according to an embodiment of the present disclosure includes memory in which at least one program is recorded and a processor for executing the program. The program includes instructions for performing acquiring an image of a first space, recognizing objects in the image, structuring information about the relationship between the objects and information about the states of the objects in the form of a graph, and merging the structured information with information received from a nearby AI agent.

Here, the objects may be recognized based on a first AI neural network that is pretrained by receiving an image of a specific space as input, and the information about the states of the objects may be acquired by inputting the objects to a second AI neural network that is trained based on training data, which is formed by labeling objects with respective states.

Here, merging the structured information may comprise merging information corresponding to the first space with information corresponding to a second space of the nearby AI agent.

Here, the merged information may be configured such that the positional relationship between the first space and the second space is represented in the form of a link.

Here, merging the structured information may comprise determining whether to merge the structured information with the information received from the nearby AI agent based on metadata of the nearby AI agent, and the metadata may include timestamp information corresponding to the information about the states of the objects.

Here, merging the structured information may comprise merging the information about the states of the objects determined to have been updated within a preset time period back from the current time using the timestamp information.

Here, merging the structured information may comprise exchanging information about an object, the state of which changes over time, with the nearby AI agent.

Here, merging the structured information may comprise exchanging information in units of sentences generated based on the information about the states of the objects with the nearby AI agent.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 conceptually illustrates a problem with conventional technology for scene understanding by a single agent;

FIG. 2 conceptually illustrates a problem with conventional technology for scene understanding by multiple agents;

FIG. 3 is a flowchart illustrating a method for organizing and merging scene understanding information of an AI agent according to an embodiment of the present disclosure;

FIG. 4 is an example of organizing scene understanding information of a single agent over time;

FIG. 5 is an example of combining multiple scenes based on the movement of a single agent or information exchange between multiple agents;

FIG. 6 is a view conceptually illustrating a method for generating sentence information based on scene understanding information according to an embodiment of the present disclosure;

FIGS. 7 to 9 are views conceptually illustrating a method for exchanging and merging scene understanding information according to an embodiment of the present disclosure; and

FIG. 10 is a view illustrating the configuration of a computer system according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

In the present specification, each of expressions such as “A or B”, “at least one of A and B”, “at least one of A or B”, “A, B, or C”, “at least one of A, B, and C”, and “at least one of A, B, or C” may include any one of the items listed in the expression or all possible combinations thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

Hereinafter, embodiments of the present disclosure will be described in detail with reference to the accompanying drawings. In the following description of the present disclosure, the same reference numerals are used to designate the same or similar elements throughout the drawings, and repeated descriptions of the same components will be omitted.

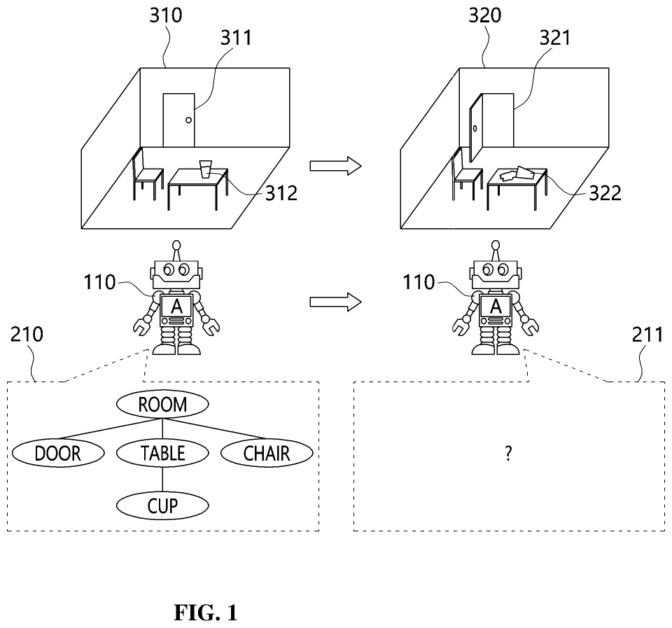

FIG. 1 conceptually illustrates a problem with conventional technology for scene understanding by a single agent.

Referring to FIG. 1, respective objects are recognized and represented in the form of a graph. That is, a scene graph, which is used for understanding the relationship between objects, is used in order to recognize and understand visual information. Here, because there is no specific method for representing a scene change (changes in the states of the objects), changes in situations, i.e., “a door is opened” or “a cup of water is spilled on a table”, cannot be represented. Also, in the existing scene, it is difficult to specifically describe changes in the scene over time. Assuming that agent A 110 is viewing a specific space 310, the positions of objects therein and the attributes thereof continue to change over time. For example, when the door is opened (311, 321) or when a cup of water is spilled on the table (312, 322), these cases 211 cannot be represented using the existing scene graph 210.

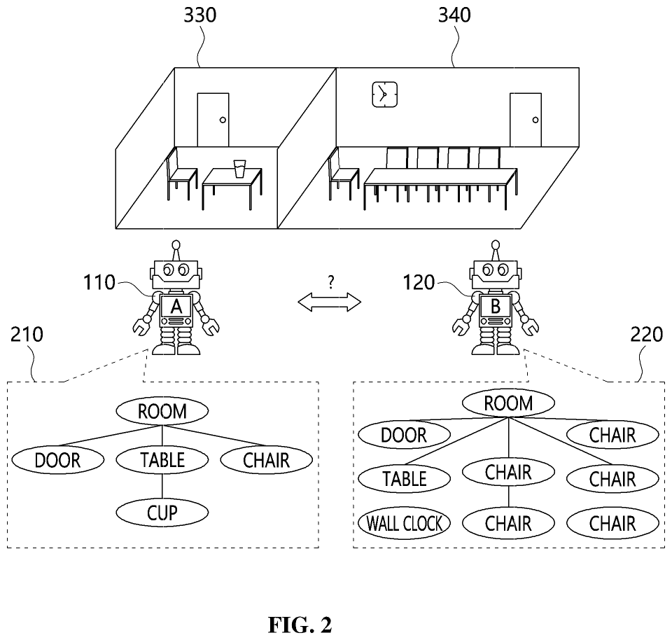

FIG. 2 conceptually illustrates a problem with conventional technology for scene understanding by multiple agents.

Referring to FIG. 2, a structure in which it is difficult to merge pieces of scene understanding information 210 and 220 for different spaces 330 and 340, which are respectively acquired by AI agent A 110 and AI agent B 120, is illustrated.

That is, after a single robot recognizes objects in a specific space and another robot recognizes objects in another space, when the relationship between the objects is described in the form of a scene graph, it is impossible to share repetitive recognition and understanding phases between the robots through scene integration (by merging the scene graphs of the robots).

In order to solve the above-mentioned problem with the conventional technology, the present disclosure proposes a method and system for organizing and understanding a scene from the view of multiple agents in order to smooth the representation of changes in objects and scene integration.

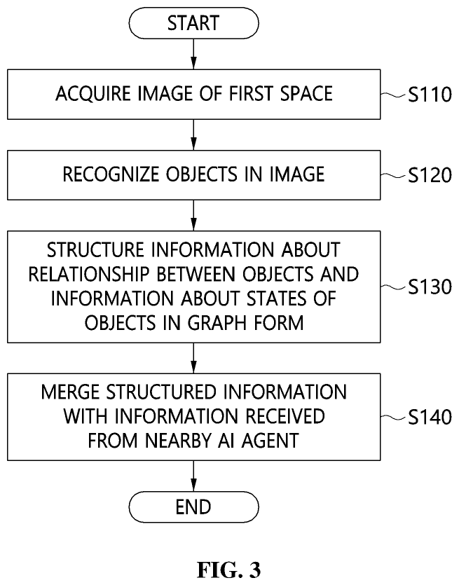

FIG. 3 is a flowchart illustrating a method for organizing and merging scene understanding information of an AI agent according to an embodiment of the present disclosure.

The method for organizing and merging scene understanding information of an AI agent according to an embodiment of the present disclosure may be performed by the AI agent, and may alternatively be performed in such a way that a separate device, such as a server, transmits instructions to the AI agent.

Referring to FIG. 3, the method for organizing and merging scene understanding information of an AI agent according to an embodiment of the present disclosure includes acquiring an image of a first space at step S110, recognizing objects in the image at step S120, structuring information about the relationship between the objects and information about the states of the objects in the form of a graph at step S130, and merging the structured information with information received from a nearby AI agent at step S140.

Here, the objects may be recognized based on a first AI neural network that is pretrained based on an image of a specific space, and the information about the states of the objects may be acquired by inputting the objects to a second AI neural network that is trained based on training data formed by labeling objects with respective states.

Here, merging the structured information at step S140 may comprise merging information corresponding to the first space with information corresponding to a second space of the nearby AI agent.

Here, the merged information may be configured such that the positional relationship between the first space and the second space is represented in the form of a link.

Here, merging the structured information at step S140 may comprise determining whether to merge the structured information with the received information based on metadata of the nearby AI agent, and the metadata may include timestamp information corresponding to the information about the states of the objects.

Here, merging the structured information at step S140 may comprise merging the information about the states of the objects determined to have been updated within a preset time period back from the current time using the timestamp information.

Here, merging the structured information at step S140 may comprise exchanging information about an object, the state of which changes over time, with the nearby AI agent.

Here, merging the structured information at step S140 may comprise exchanging information in units of sentences generated based on the information about the states of the objects with the nearby AI agent.

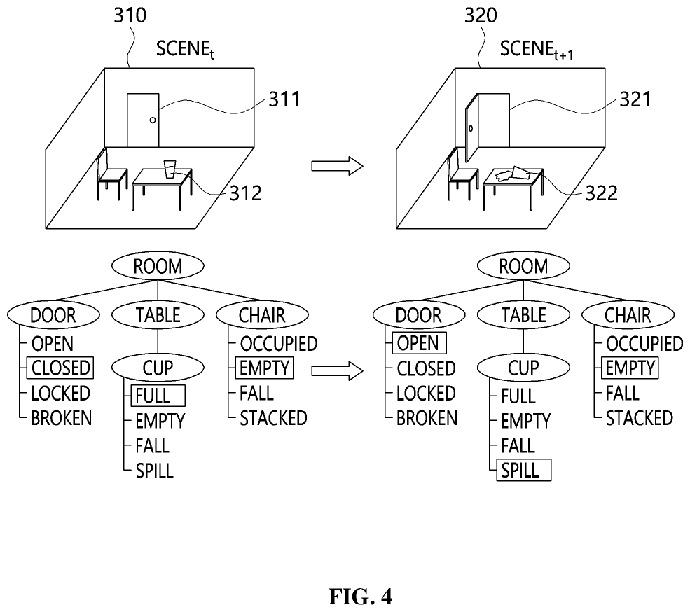

Hereinafter, a method for organizing and merging scene understanding information according to an embodiment of the present disclosure will be described in more detail with reference to FIGS. 4 to 7.

FIG. 4 is an example in which a single agent organizes scene understanding information over time.

Referring to FIG. 4, the present disclosure relates to a method for structuring a specific space from the view of an agent, and when a scene 310 at a specific time point is given, respective objects are recognized first. Then, the relationship between the objects is structured in the form of a graph. Here, the relationship of objects present in a single space may be structured using existing technology. Here, the method according to an embodiment of the present disclosure uses a method of newly defining semantic details of each object and adding the same to the structure information of the object. For example, meanings such as ‘open’, ‘closed’, ‘locked’, ‘broken’, and the like may be imparted to a door 311 or 321. By imparting such meanings, a change in the object may continue to be recognized at a subsequent time point 320. Here, it can be seen that the door that used to be ‘closed’ is changed to ‘open’ at the time point 320 after a specific time point. Also, the state of a cup 312 or 322 on a table may be changed from the state in which the cup is full of water to the state in which water spills out of the cup.

Here, the process of defining state information of each object as described above may be performed through a special AI neural network. That is, an AI neural network configured to receive sub-images acquired by separating objects in a scene graph and output object state information corresponding to the sub-images may be used.

Here, the AI neural network that outputs the state information may be an AI neural network that is trained using training data labeled with each object and state information. That is, the AI neural network configured to use images labeled with ‘the closed door’, ‘the opened door’, ‘the locked door’, ‘the broken door’, and the like, as described above, as training data may be used.

Consequently, the method according to an embodiment of the present disclosure may generate a scene graph (recognize objects and the relationship between the objects) by receiving images collected using the camera of an agent and define state information of each of the recognized objects.

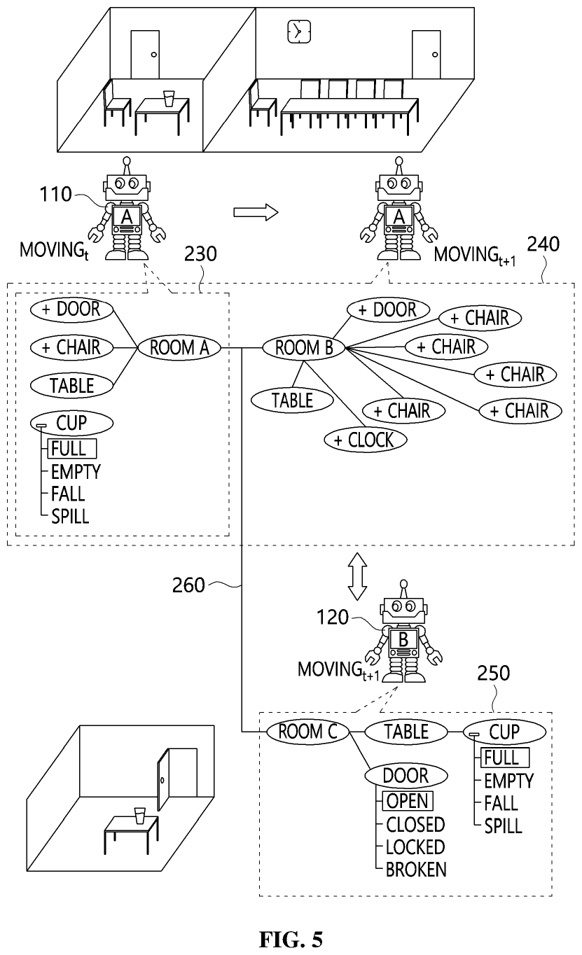

FIG. 5 is an example of combining multiple scenes based on the movement of a single agent or information exchange between multiple agents.

Referring to FIG. 5, when it is assumed that agent A 110 continues understanding scenes over time, as shown in FIG. 4, understanding 240 of another scene that agent A views by moving to another space is required. Here, while it is gradually moving, the single agent combines the scene 230 already understood thereby with a newly acquired scene, thereby organizing new scene understanding information 240.

Also, AI agent B 120, which is a new AI agent, communicates with AI agent A at a specific time point, whereby the pieces of scene understanding information 230 and 240 are combined (260) with another piece of scene understanding information 250. In the present disclosure, organizing and understanding scenes from the view of multiple agents in this way are proposed.

Here, in order to represent the combination, the positional relationship between the spaces may be represented in the form of a link.

Here, in the process in which agent A and agent B combine the pieces of scene understanding information, they may combine only the pieces of scene understanding information that satisfy a preset condition, rather than combining all of the pieces of scene understanding information.

For example, when respective agents generate scene understanding information, timestamp data may be included as metadata thereof. Also, when objects in the scene understanding information and the attributes of the objects are updated, the timestamp data may be updated.

When agents combine the pieces of scene understanding information thereof (that is, exchange data with each other), they may use timestamp information. For example, when the scene understanding information about ROOM 1 was generated by agent A an hour ago and when the scene understanding information about ROOM 2 was generated 15 minutes ago, agent B may combine or update only the scene understanding information about ROOM 2.

As described above, only the scene understanding information satisfying a specific condition is combined or updated, whereby unnecessary data exchange may be reduced and the size of the combined data may be prevented from becoming too large.

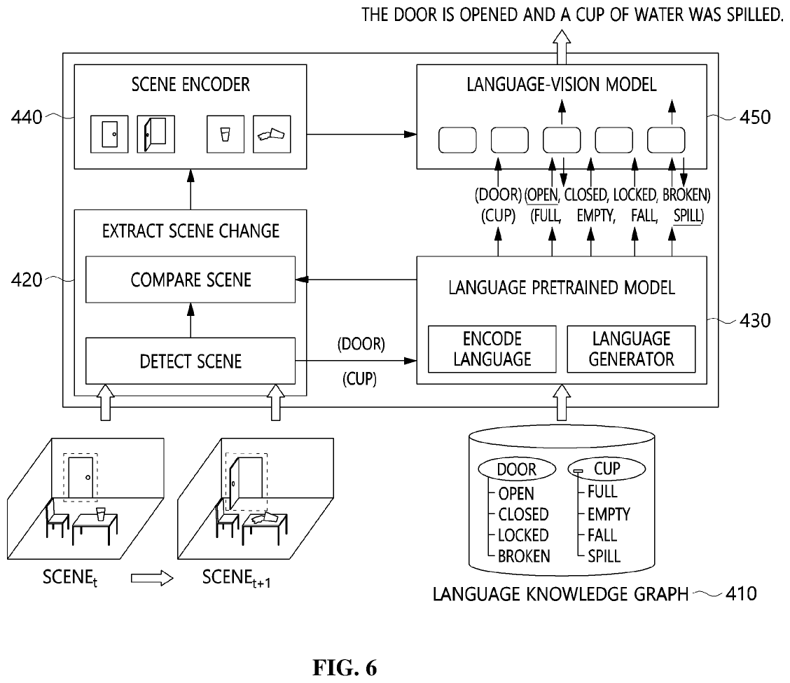

FIG. 6 is a view conceptually illustrating a method of generating sentence information based on scene understanding information according to an embodiment of the present disclosure.

Referring to FIG. 6, when a given scene is changed at a specific time point, the scene is detected through a scene detection unit. For the detected scene, the labels of respective objects (e.g., door, cup) are input to a language pretrained model 430. The language pretrained model 430 selects words that can be added to the input labels. For example, when ‘door’ is given and when there is a case in which a door is opened, closed, locked, or broken, this is used. Here, a predefined language knowledge graph 410 is used in order to acquire such information. Subsequently, the language pretrained model selects available sentences. Also, through the scene detection result, a scene comparison unit finds a changed scene using a scene encoder 440. Using the changed scenes found by the scene encoder 440 and the potential candidate words having been found by the language pretrained model, a language-vision model 450 generates a suitable summary sentence based on the changes in the scene. Using the sentences generated as described above, multiple agents combine the sentences by communicating and cooperating with each other, whereby overall summary information is generated.

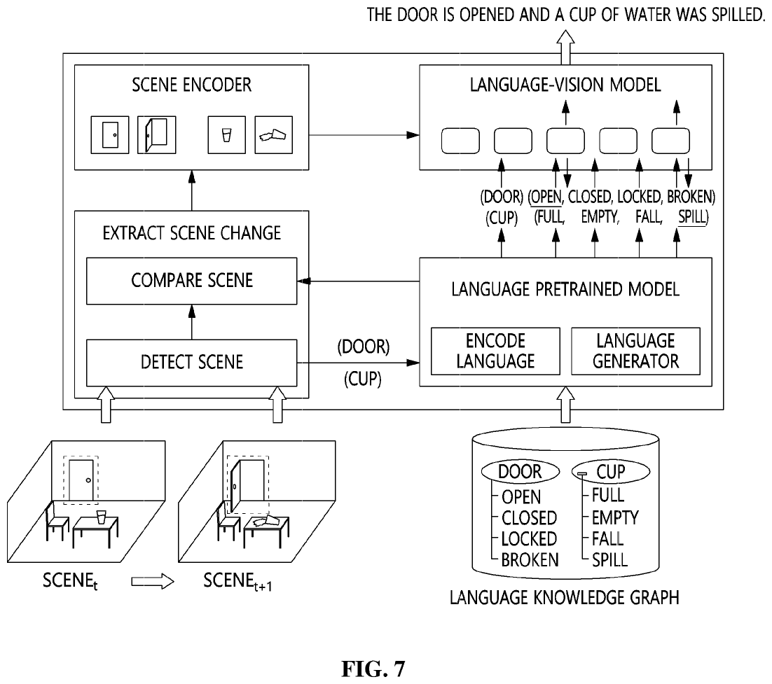

FIGS. 7 to 9 are views conceptually illustrating a method for exchanging and combining scene understanding information according to an embodiment of the present disclosure.

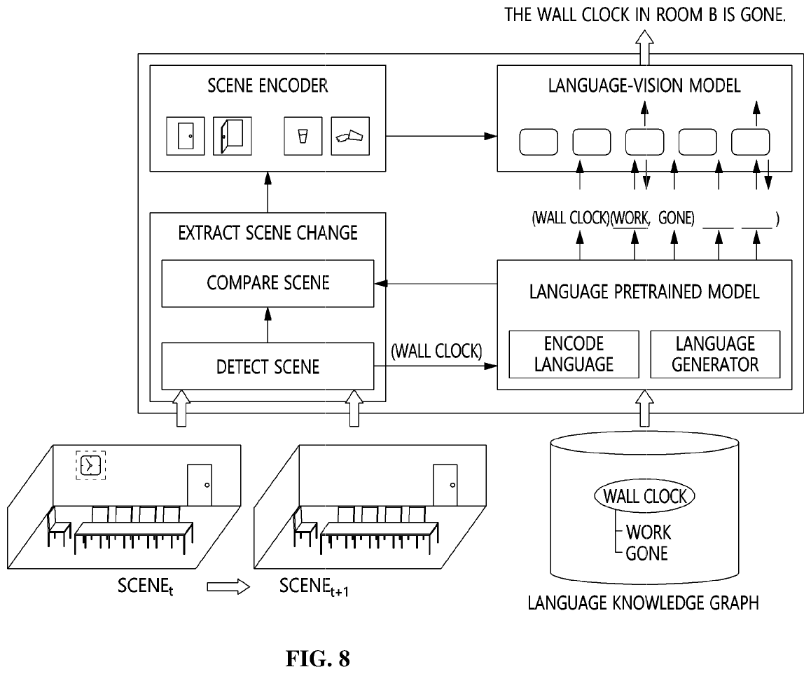

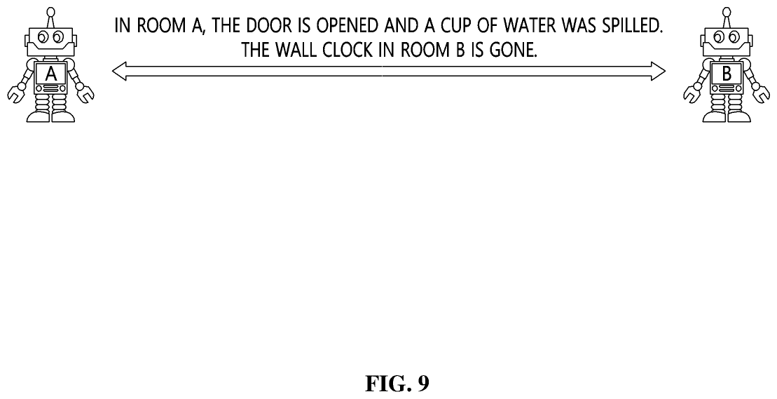

FIG. 7 illustrates a linguistic summary generated by AI agent A, and FIG. 8 illustrates a linguistic summary generated by AI agent B. FIG. 9 illustrates the process of exchanging the linguistic summaries respectively generated by AI agent A and AI agent B.

The method in which a single agent generates a linguistic summary, as illustrated in FIG. 6, may be described from the view of multiple agents. That is, if two agents are present, when their situations change, this may be represented as linguistic summaries. Accordingly, when multiple agents are present, various changes in circumstances may be organized and understood through a linguistic combination.

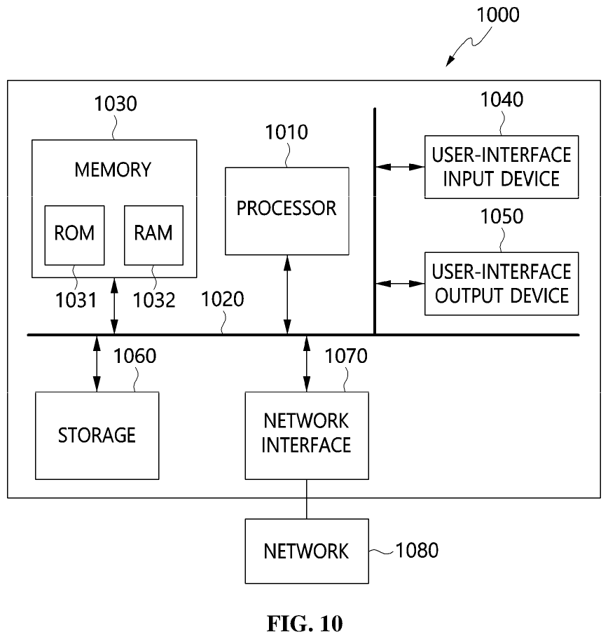

FIG. 10 is a view illustrating the configuration of a computer system according to an embodiment.

The apparatus for organizing and merging scene understanding information of an AI agent according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

The apparatus for organizing and merging scene understanding information of an AI agent according to an embodiment of the present disclosure includes memory 1030 in which at least one program is recorded and a processor 1010 for executing the program. The program includes instructions for performing the steps of acquiring an image of a first space, recognizing objects in the image, structuring information about the relationship between the objects and information about the states of the objects in the form of a graph, and merging the structured information with information received from a nearby AI agent.

Here, the objects may be recognized based on a first AI neural network that is pretrained by receiving an image of a specific space as input, and the information about the states of the objects may be acquired by inputting the objects to a second AI neural network that is trained based on training data formed by labeling objects with respective states.

Here, merging the structured information may comprise merging information corresponding to the first space with information corresponding to a second space of the nearby AI agent.

Here, the merged information may be configured such that the positional relationship between the first space and the second space is represented in the form of a link.

Here, merging the structured information may comprise determining whether to merge the structured information with the received information based on metadata of the nearby AI agent, and the metadata may include timestamp information corresponding to the information about the states of the objects.

Here, merging the structured information may comprise merging the information about the states of the objects determined to have been updated within a preset time period back from the current time using the timestamp information.

Here, merging the structured information may comprise exchanging information about an object, the state of which changes over time, with the nearby AI agent.

Here, merging the structured information may comprise exchanging information in units of sentences generated based on the information about the states of the objects with the nearby AI agent.

According to the present disclosure, scene understanding information including the relationship between objects may be generated based on scene information acquired by an AI agent.

Also, the present disclosure may efficiently exchange and merge pieces of scene understanding information respectively generated by multiple AI agents.

Specific implementations described in the present disclosure are embodiments and are not intended to limit the scope of the present disclosure. For conciseness of the specification, descriptions of conventional electronic components, control systems, software, and other functional aspects thereof may be omitted. Also, lines connecting components or connecting members illustrated in the drawings show functional connections and/or physical or circuit connections, and may be represented as various functional connections, physical connections, or circuit connections that are capable of replacing or being added to an actual device. Also, unless specific terms, such as “essential”, “important”, or the like, are used, the corresponding components may not be absolutely necessary.

Accordingly, the spirit of the present disclosure should not be construed as being limited to the above-described embodiments, and the entire scope of the appended claims and their equivalents should be understood as defining the scope and spirit of the present disclosure.

What is claimed is:

1. A method for organizing and merging a scene of an Artificial Intelligence (AI) agent, comprising:
acquiring an image of a first space;
recognizing objects in the image;
structuring information about a relationship between the objects and information about states of the objects in a form of a graph; and
merging the structured information with information received from a nearby AI agent.

2. The method of claim 1, wherein:
the objects are recognized based on a first AI neural network that is pretrained by receiving an image of a specific space as input, and
the information about the states of the objects is acquired by inputting the objects to a second AI neural network that is trained based on training data formed by labeling objects with respective states.

3. The method of claim 1, wherein merging the structured information comprises merging information corresponding to the first space with information corresponding to a second space of the nearby AI agent.

4. The method of claim 3, wherein the merged information is configured such that a positional relationship between the first space and the second space is represented in a form of a link.

5. The method of claim 1, wherein
merging the structured information comprises determining whether to merge the structured information with the information received from the nearby AI agent based on metadata of the nearby AI agent, and
the metadata includes timestamp information corresponding to the information about the states of the objects.

6. The method of claim 5, wherein merging the structured information comprises merging the information about the states of the objects determined to have been updated within a preset time period back from a current time using the timestamp information.

7. The method of claim 1, wherein merging the structured information comprises exchanging information about an object, a state of which changes over time, with the nearby AI agent.

8. The method of claim 1, wherein merging the structured information comprises exchanging information in units of sentences generated based on the information about the states of the objects with the nearby AI agent.

9. An apparatus for organizing and merging a scene of an Artificial Intelligence (AI) agent, comprising:
memory in which at least one program is recorded; and
a processor for executing the program,
wherein the program includes instructions for performing
acquiring an image of a first space,
recognizing objects in the image,
structuring information about a relationship between the objects and information about states of the objects in a form of a graph; and
merging the structured information with information received from a nearby AI agent.

10. The apparatus of claim 9, wherein:
the objects are recognized based on a first AI neural network that is pretrained by receiving an image of a specific space as input, and
the information about the states of the objects is acquired by inputting the objects to a second AI neural network that is trained based on training data formed by labeling objects with respective states.

11. The apparatus of claim 9, wherein merging the structured information comprises merging information corresponding to the first space with information corresponding to a second space of the nearby AI agent.

12. The apparatus of claim 11, wherein the merged information is configured such that a positional relationship between the first space and the second space is represented in a form of a link.

13. The apparatus of claim 9, wherein
merging the structured information comprises determining whether to merge the structured information with the information received from the nearby AI agent based on metadata of the nearby AI agent, and
the metadata includes timestamp information corresponding to the information about the states of the objects.

14. The apparatus of claim 13, wherein merging the structured information comprises merging the information about the states of the objects determined to have been updated within a preset time period back from a current time using the timestamp information.

15. The apparatus of claim 9, wherein merging the structured information comprises exchanging information about an object, a state of which changes over time, with the nearby AI agent.

16. The apparatus of claim 9, wherein merging the structured information comprises exchanging information in units of sentences generated based on the information about the states of the objects with the nearby AI agent.
